(19) United States
(12) Patent Application Publication
(10) Pub. No.: US 2005/0206527 A1
(43) Pub. Date: Sep. 22, 2005

(54) Radiator warning system of semiconductor manufacturing equipment

(76) Inventors: Sheng Chuan Peng, Hsinchu City (TW); Shun Chun Chow, Changhua City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/802,790

(22) Filed: Mar. 18, 2004

(51) Int. Cl. G08B 21/00

(52) U.S. Cl. 340/648; 340/679; 340/686.1; 340/606; 340/626

(57) ABSTRACT

The present invention discloses a radiator warning system of semiconductor manufacturing equipment. The radiator warning system has a light foil floating with airflow of the radiator. When the radiator is operated normally, the light foil is blown by airflow of the radiator to touch a contact detecting apparatus, and when the radiator is operated abnormally, the light foil does not touch the contact detecting apparatus. At this moment, a warning apparatus will send a warning signal. With the design of the claimed radiator warning system, the radiator can be inspected immediately while abnormal, and prevent the shutdown after exceeding temperature.

### BACKGROUND OF INVENTION

1. Field of the Invention

The invention relates to a warning system of a radiator, and more particularly, to a warning system of a radiator using in a semiconductor manufacturing equipment.

2. Description of the Prior Art

With the progress of the semiconductor process technology, a variety of small chips with powerful functions changes our life. The electric products with chips help people to solve many problems.

In the semiconductor manufacturing equipment, furnace is an important process equipment while proceeding the semiconductor processes, such as oxidation, diffusion, chemical vapor deposition and heat treatment. Generally, several furnaces are installed together to form a furnace group, and four furnaces in a group is the most popular situation for convenience and management. The furnace group is further installed control apparatus and gas lines. The furnace group is equipment for high temperature process, and the surrounding temperature is very high while operating. For avoiding the surrounding equipment from being damaged by the furnace group, the furnace group is installed with radiators and temperature detectors. The temperature detector in the furnace group is set for a predetermined temperature, and when the temperature of the furnace group exceeds the setting value, the furnace group will be stop automatically to ensure the safety. Generally, the unusual temperature is caused by abnormality of the radiators.

Besides the furnace equipments mentioned above, the radiators are also utilized in many semiconductor manufacturing equipments. But the radiators in the furnace or other semiconductor manufacturing equipments all have some disadvantages. While the radiator is abnormal and causes high temperature, the equipment will not stop until the temperature is higher than the predetermined warning value. The equipment needs to be shut down to inspect and the wafers in the equipment will be scrapped. Hence, a more ideal warning system to prevent the above situation is desired.

### SUMMARY OF INVENTION

It is therefore a primary objective of the claimed invention to provide a warning system to detect the abnormality of the radiator in a semiconductor manufacturing equipment and send a warning signal.

It is therefore another objective of the claimed invention to provide a warning system for detecting the abnormality of the radiator in a semiconductor manufacturing equipment to prevent the equipment from stop with exceeding temperature and scrap all the wafers in the equipment.

According to the claimed invention, a warning system of a radiator installed on a semiconductor manufacturing equipment is disclosed. The warning system includes a contact detecting apparatus; a light foil floating with dissipating airflow in one end, when the radiator is operated normally, the light foil is blown by dissipating airflow to touch the contact detecting apparatus, and when the radiator is operated abnormally, the light foil does not touch the contact detecting apparatus; and a warning apparatus connected with the contact detecting apparatus, when the light foil does not touch the contact detecting apparatus, the warning apparatus send a warning signal.

According to another embodiment of the claimed invention, the warning system includes a contact detecting apparatus; a light foil floating with dissipating airflow in one end, when the radiator is operated abnormally, the light foil will touch the contact detecting apparatus, and when the radiator is operated normally, the light foil is blown by dissipating airflow to keep the contact detecting apparatus untouched; and a warning apparatus connected with the contact detecting apparatus, when the light foil touches the contact detecting apparatus, the warning apparatus send a warning signal. With the design of the claimed warning system, the radiator can be inspected immediately while abnormal, and prevent the shutdown after exceeding temperature.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

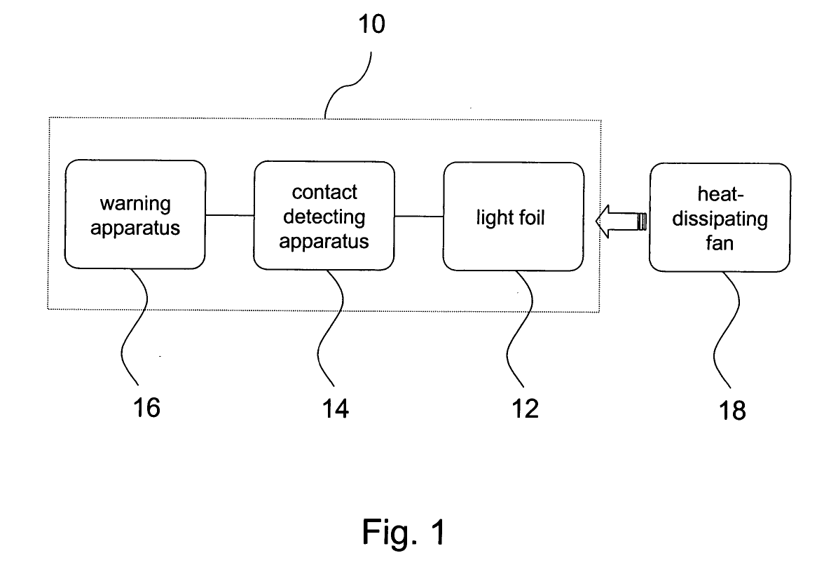

FIG. 1 is a schematic diagram of a warning system according to the present invention.
10 warning system
12 light foil
14 contact detecting apparatus
16 warning apparatus
18 radiator

### DETAILED DESCRIPTION

For solving the disadvantage of that the semiconductor manufacturing equipment is automatically stopped to protect the machine while the abnormal radiator leads to the high temperature and scraps all wafers in the machine, a warning system is disclosed to detect the abnormality of the radiator without being delayed till the inspection.

As shown in FIG. 1, the warning system 10 includes a light foil 12, a contact detecting apparatus 14 that can detect the contact situation with the light foil 12, and a warning apparatus 16 that can send warning signals. The warning system 10 is installed nearby the radiator 18 of the semiconductor manufacturing equipment, and the light foil 12 floats with dissipating airflow. One end of the light foil 12 can float with dissipating airflow and the other end is fixed. When the radiator 18 is operated normally, the light foil 12 is blown by dissipating airflow and the floating end is continuously kept touching the contact detecting apparatus 14. When the radiator 18 is operated abnormally, the light foil 12 goes back to the original position and does not touch the contact detecting apparatus 14. At this moment, the contact detecting apparatus 14 will trigger the warning apparatus 16 to send a warning signal for informing related people to check the radiator 18. This warning system 10 can prevent shutting down the machine till the temperature is high.

Generally, the radiator in the semiconductor manufacturing equipment is composed of a plurality of fans, and the heat dissipation efficiency is affected while one of the fans is broken. Hence, in the preferred embodiment, each exhaust of the fans can be installed with the light foil 12 and the corresponding contact detecting apparatus 14, and connecting all the contact detecting apparatus 14 to the same warning apparatus 16. If any fan of the radiator is abnormal and does not rotate, the warning apparatus 16 will send a warning signal to ensure every fan is operated normally to help dissipating heat of the semiconductor manufacturing equipment. The warning apparatus 16 of the warning system 10 can further connected to the console of the semiconductor manufacturing equipment. When the radiator is abnormal, the warning system 10 can send a warning signal to the console to inform the operator and help the operator to solve problem immediately. In addition, the warning signal of the warning apparatus 16 can also be an audio signal or a flashing signal. All apparatus that can inform the operator can be the warning signal outputted by the warning apparatus.

In another embodiment, the light foil 12 can continuously keep touching the contact detecting apparatus 14 while not blown by dissipating airflow. When the radiator 18 is operated normally, the light foil 12 will not touch the contact detecting apparatus 14. The warning apparatus 16 is connected to the contact detecting apparatus 14, and the contact detecting apparatus 14 will trigger the warning apparatus 16 to send a warning signal while the light foil 12 and the contact detecting apparatus 14 are touched. So, when the radiator 18 is operated abnormally, the light foil 12 will touch the contact detecting apparatus 14, and the warning apparatus 16 is triggered to send a warning signal.

In contrast to the prior art, the present invention discloses a warning system that can send a warning signal to inform the related people to inspect while the radiator is abnormal, so that the semiconductor manufacturing equipment will not exceed the predetermined temperature to stop automatically. Hence, the claimed warning system can effectively prevent the semiconductor manufacturing equipment from being stopped by high temperature and avoid the huge damage of scrapping all wafers in the semiconductor manufacturing equipment.

Those skilled in the art will readily observe that numerous modifications and alterations of the device may be made while retaining the teachings of the invention. Accordingly, the above disclosure should be construed as limited only by the metes and bounds of the appended claims.

1. A warning system of a radiator installed on a semiconductor manufacturing equipment having the radiator, the warning system comprising:
a contact detecting apparatus;
a light foil floating with dissipating airflow in one end, when the radiator is operated normally, the light foil is blown by dissipating airflow to touch the contact detecting apparatus, when the radiator is operated abnormally, the light foil does not touch the contact detecting apparatus; and
a warning apparatus connected with the contact detecting apparatus, when the light foil does not touch the contact detecting apparatus, the warning apparatus will send a warning signal.

2. The warning system of claim 1, wherein the warning system is installed on the semiconductor manufacturing equipment having the radiator composed of at least one fans.

3. The warning system of claim 1, wherein the warning signal is an audio signal.

4. The warning system of claim 1, wherein the warning signal is a flashing signal.

5. The warning system of claim 1, wherein the warning apparatus is connected to a console of the semiconductor manufacturing equipment.

6. The warning system of claim 1, wherein the warning system is equipped the light foil and the contact detecting apparatus at each exhaust of the radiator, and all of the contact detecting apparatus are connected to the same warning apparatus.

7. A warning system of a radiator installed on a semiconductor manufacturing equipment having the radiator, the warning system comprising:
a contact detecting apparatus;
a light foil floating with dissipating airflow in one end, when the radiator is operated abnormally, the light foil touches the contact detecting apparatus, when the radiator is operated normally, the light foil is blown by dissipating airflow to keep the contact detecting apparatus untouched; and
a warning apparatus connected with the contact detecting apparatus, when the light foil touches the contact detecting apparatus, the warning apparatus will send a warning signal.

8. The warning system of claim 7, wherein the warning system is installed on the semiconductor manufacturing equipment having the radiator composed of at least one fans.

9. The warning system of claim 7, wherein the warning signal is an audio signal.

10. The warning system of claim 7, wherein the warning signal is a flashing signal.

11. The warning system of claim 7, wherein the warning apparatus is connected to a console of the semiconductor manufacturing equipment.

12. The warning system of claim 7, wherein the warning system is equipped the light foil and the contact detecting apparatus at each exhaust of the radiator, and all of the contact detecting apparatus are connected to the same warning apparatus.
